(19) United States
(12) Patent Application Publication
(10) Pub. No.: US 2002/0107790 A1
(43) Pub. Date: Aug. 8, 2002

(54) System and method for extending automatically secured credit to building project owners and to building contractors for purchasing building supplies from building supply wholesalers

(76) Inventor: James A. Nielson, Scottsdale, AZ (US)

Correspondence Address: Brian C. Kunzler, 10 West 100 South, Salt Lake City, UT, 84101, US

(21) Appl. No.: 10/072,552

(22) Filed: Feb. 7, 2002

Related U.S. Application Data
(60) Provisional application No. 60/266,986, filed on Feb. 7, 2001.

(51) Int. Cl. G06F 17/60

(52) U.S. Cl. 705/38

(57) ABSTRACT

A system and method for extending automatically secured credit to building project owners and to building contractors for the purpose of purchasing building supplies from building supply wholesalers provides building contractors, owners, and materialmen with a more secure, less risky means of financing materials purchases for building projects. A contractor enters into a contractual agreement with a third-party lender to purchase supplies on credit from a building supply wholesaler. The building supply wholesaler also contracts with the lender to have the lender manage their sales on account to contractors approved by the lender. In exchange for lender's promises to extend credit upon approval to contractors it approves and to pay approved contractors' accounts with the building supply wholesaler, both the contractor and the wholesaler assign their rights to record and enforce mechanics' liens relating to the building supplies to the lender. The system and method may employ the use of digital signature and notary technologies as well as electronic recording of liens.

RELATED APPLICATIONS

The present application is a continuation-in-part of and claims priority to U.S. Provisional Patent Application No. 60/266,986 entitled SYSTEM AND METHOD FOR EXTENDING AUTOMATICALLY SECURED CREDIT TO BUILDING PROJECT OWNERS AND TO BUILDING CONTRACTORS FOR THE PURPOSE OF PURCHASING BUILDING SUPPLIES FROM BUILDING SUPPLY WHOLESALERS filed on Feb. 7, 2001.

### BACKGROUND OF THE INVENTION

1. The Field of the Invention

The present invention relates to extending credit to building project owners and building contractors for the purpose of purchasing building supplies from building supply wholesalers. More specifically, the present invention relates to the use of contractually assigned mechanics' liens to secure extensions of credit from a lender to building project owners and building contractors for the purpose of purchasing building supplies from building supply wholesalers.

2. The Relevant Art

The extension of credit on account from building material suppliers to building project owners and building contractors is generally a risky proposition. Such extensions of credit on an open account are unsecured. State law provides means by which such credit extensions may be secured through the recording of mechanics' liens. However, there are numerous complicating factors in the securing of such credit extensions.

First, the time period in which a building material supplier may record a lien against a building project is typically quite short. Second, the practice of recording liens against building projects by the building material supplier frequently leads to disfavor of the supplier within the community of contractors, whose good reputation and livelihood generally depend upon their ability to construct building projects in a timely manner while preserving the lien-free status of the title to the building project. Third, the time period in which a building material supplier may file a legal action to foreclose upon a mechanic's lien is generally very short and such short time frames are frequently forgotten by building material suppliers and contractors alike, leading to the result of having an unenforceable lien.

The typical contractual arrangement between a building material supplier and a building contractor is very simple. Generally, the contractor applies for an open credit account with the supplier and signs an open account agreement containing the terms and conditions governing the extension of credit for the purchase of supplies. The agreement typically sets forth payment terms, including the period of time which may transpire between the date of the purchase and the date of payment from the contractor to the supplier. Occasionally, however, the contractor fails to make the required payment by the date contractually due. The supplier is then faced with a dilemma, to wit, if the supplier ceases to extend credit for purchases and records liens against the underlying building projects, then the contractor will simply stop doing business with the supplier and open an account elsewhere. Further complicating the foregoing scenario is the fact that the supplier's sales staff frequently neglect to gather sufficient information from the contractor to enable the supplier to prepare a recordable and enforceable mechanic's lien.

Yet another difficulty frequently encountered by building suppliers is that, given the volume of sales to contractors on account, it is quite time-consuming and labor-intensive to monitor deadlines for recording liens and commencing legal action to enforce the liens which have been recorded. The recording deadlines and statute of limitation deadlines are jurisdictional, i.e., once the deadlines have passed, the ability to record or enforce a lien has been permanently waived and the debt loses its secured status, thus resulting in a dramatically increased difficulty in collection.

Finally, in order to maintain a good relationship with their customers, suppliers are frequently reluctant to record mechanics' liens against building projects, even when a contractor's account is past due. Such is the nature and culture in the construction industry.

From the foregoing discussion, it can be seen that a need exists for an improved method and system for extending credit to building contractors for the purpose of purchasing materials from suppliers.

### OBJECT AND BRIEF SUMMARY OF THE INVENTION

The system and method of the present invention has been developed in response to the present state of the art, and in particular, in response to the problems and needs in the art that have not yet been fully solved by currently available systems and methods. Accordingly, it is an overall object of the present invention to provide a system and method that overcomes many or all of the above-discussed shortcomings in the art.

The present invention provides a system and method for extending automatically secured credit to building project owners and to building contractors for the purpose of purchasing building supplies from building supply wholesalers.

Under the invention, a building contractor who desires to purchase building supplies from a building supply wholesaler applies for a line of credit with a third-party credit company or lender with whom the building supply wholesaler has contracted to provide credit approval and management services to the building supply wholesaler. The credit company then reviews the building contractor's credit application and, if approved, extends the building contractor a revolving line of credit for the purpose of purchasing only building supplies from the building supply wholesaler. The preferred manner of making this application also makes use of electronic means, digital signature, and digital notary public acknowledgment technologies.

Each purchase is made for a particular building project, which is identified at the time of the purchase by the use of a unique identification number for each separate building project, which is assigned by the credit company. The ordering and purchasing of building supplies by the building contractor may take place in person, over the telephone, via the Internet, or other electronic means. Before the sale can be consummated, all pertinent information regarding the building supply purchase, including specific identification of which building project in which the supplies are to be used, is electronically conveyed to the credit company, which either approves or disapproves the extension of credit to the building contractor based on factors such as the building contractor's available credit with the credit company and payment history. If the extension of credit is approved, the purchase information, including all information required for the filing of a mechanic's lien under the law of the state where the building project is located, is stored in the credit company's electronic database. The required information is preferably obtained via electronic means.

Pursuant to the initial contractual relationship between the credit company and the building supply wholesaler, at the time each individual purchase is made, the right to record a mechanic's lien against the building project being constructed by the building contractor is automatically assigned from the building supply wholesaler to the credit company. Also pursuant to the contractual relationship between the credit company and the building contractor, at the time each individual purchase is made, the right to record a mechanic's lien against the building project being constructed by the building contractor is automatically assigned from the building supply wholesaler to the credit company.

At the close of the billing cycle for each month, the credit company's computer system analyzes the sales data regarding all sales for which credit was extended during the previous billing cycle. Preliminary notice of the right to claim a mechanic's lien is transmitted through an automated, computerized procedure to the building contractor and/or governmental entity for each new building project initiated by a building contractor during the previous billing cycle, where notice of the right to claim a lien is required by state law in the state in which the new building project is located. The preferred manner of transmitting preliminary lien notices is by electronic means, using digital signature and digital notary public acknowledgment technologies.

Midway through each billing cycle, another computerized analysis is performed by the credit company to determine the credit extensions for which mechanic's liens should be filed during that billing cycle, thus ensuring that the mechanic's liens will be filed within statutory time limits for the state in which the building project is located. The recording of a mechanic's lien against a building project is triggered in the event the building contractor fails to make payment to the credit company within the revolving credit terms offered by the credit company. If this occurs, the credit company then records its mechanic's lien against the building project and thereby secures the credit it has extended to the building contractor for each individual building project, thereby dramatically reducing the risk of uncollectability of the extended credit in the event of payment default by the building contractor.

The preferred manner of recording the mechanic's liens by the credit company incorporates the use of digital signature and digital notary public acknowledgment technologies, as well as the use of electronic means to receive notification from state and municipal agencies regarding official certification of lien recording and receipt of preliminary lien notices. Further, electronic means may employed to track and store transmitted preliminary lien notices and liens, as well as official certification of lien recording and receipt of preliminary lien notices.

Also featured in the business method is the development of a network of contractors and building supply wholesalers which use lender's credit supplying services. Information regarding members of the network of contractors and building supply wholesalers which use lender's credit supplying services may be provided to other members of the network for a variety of purposes, including marketing and business referrals.

Another embodiment of the current invention is the extension of credit in the form of a construction loan from the credit company to a person or entity who is having a building project completed by a building contractor which credit is secured by the building project and the underlying real estate. The preferred manner of this credit extension employs electronic means to complete loan applications and security documents, as well as digital signatures and digital notary public acknowledgments in the process of executing loan and security documents and recording such documents with the appropriate state and municipal agencies. Further, the method may also incorporate the use of electronic means to receive notification from state and municipal agencies regarding official certification of loan security document recordation.

Under the method, payments from the credit company are made directly to suppliers of building materials and labor for the construction project for which the construction loan was issued, including building supply wholesalers and building contractors who are part of the lender's automatically secured credit extension network. Preferably, the payments are made directly to building supply wholesalers and building contractors who are part of the credit company's automatically secured credit extension network from proceeds of the construction loan issued on behalf of the building project owner. This direct payment to members of the credit company's network decreases credit risk to all parties involved, as well as decreasing the time lapse between an individual purchase of building supplies and the date of payment from the construction loan lender or general contractor.

Also employed in the method is the use of computer software and electronic means for the purpose of ensuring that credit is not extended beyond the approved amount for any construction loan.

These and other objects, features, and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a flow diagram illustrating one embodiment of the major components of the business system and method;

FIG. 2 is a flow diagram illustrating the process of entering into and the resulting agreement between a building supply wholesaler and a lender;

FIG. 3 is a flow diagram illustrating the process of entering into and the resulting agreement between a building contractor and a lender;

FIG. 4 is a block diagram illustrating the various methods by which a contractor may make purchases from a supplier on credit provided by a lender under the business method and system;

FIG. 5 is a flow diagram illustrating the manner in which a contractor may make purchases via the Internet from a supplier on credit provided by a lender under the business method and system;

FIG. 6 is a flow diagram illustrating the manner in which a contractor may make purchases in person from a supplier on credit provided by a lender under the business method and system;

FIG. 7 is a flow diagram illustrating the manner in which a contractor may make purchases via a wireless Internet connection from a supplier on credit provided by a lender under the business method and system;

FIG. 8 is a block diagram illustrating the two discreet segments of the lender's accounting process which are further illustrated in FIGS. 9-11;

FIG. 9 is a flow diagram illustrating the accounts receivable accounting system employed by a lender under the business method and system;

FIG. 10 is a flow diagram illustrating the payment receipt analysis conducted monthly by a lender under the business method and system;

FIG. 11 is a flow diagram illustrating the accounts payable accounting system employed by a lender under the business method and system;

FIG. 12 is a flow diagram illustrating the mechanics' lien process employed by a lender under the business method and system; and

FIG. 13 is a flow diagram illustrating the extension of credit in the form of a construction loan from the credit company to a person or entity who is having a building project completed by a building contractor which credit is secured by the building project and the underlying real estate under the business method and system.

### DETAILED DESCRIPTION OF THE PREFERRED EMBODIMENTS

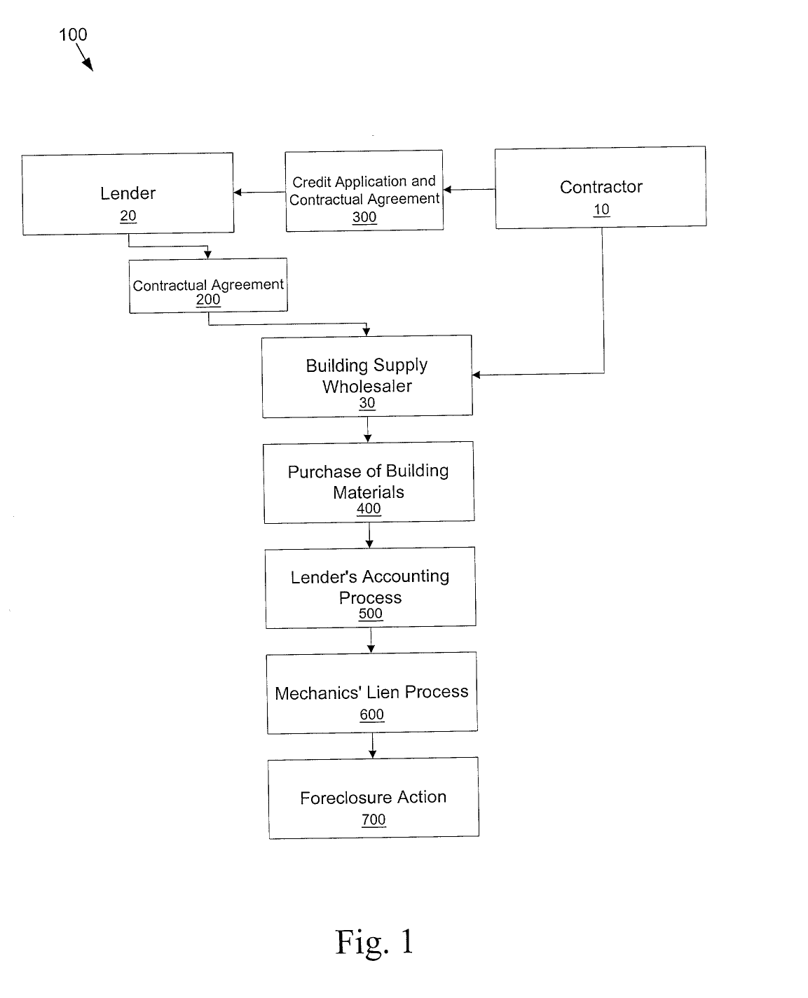

The basic embodiment of a system and method of the present invention for extending automatically secured credit to building project owners and to building contractors for the purpose of purchasing building supplies from building supply wholesalers is shown in FIG. 1. Referring now to FIG. 1, the system and method for extending automatically secured credit to building project owners and to building contractors for the purpose of purchasing building supplies from building supply wholesalers 100 may include a credit application and contractual agreement 300 completed by a licensed building contractor 10 for the purpose of obtaining a line of credit with a lender 20 for use in making a purchase of building materials 400 for use in a particular building project from a building supply wholesaler 30. Before a contractor 10 may make purchases on credit from the lender 20, the building supply wholesaler 30 must enter into a contractual agreement 200 with the lender 20 for the purpose of having the lender 20 provide credit to a contractor 10 to make such a purchase of building materials 400 from the building supply wholesaler 30.

Once a purchase of building materials 400 has been effected by a contractor 10 on credit extended by a lender 20, the purchase of building materials 400 is then reported to the lender's accounting process 500, at which point, a mechanic's lien process 600 may be triggered for the purpose of securing the credit extended. In the event of a failure by a contractor 10 to pay a lender 20 for a purchase of building materials 400 within the terms and conditions of the credit application and contractual agreement 300, a continuation of procedures in a mechanics' lien process 600 may be triggered for the purpose of securing the credit extended. Further, in the event of a failure by a contractor to pay a lender 20 for a purchase of building materials 400 within the statutory time period set forth in state law, a lender 20 may commence a foreclosure action 700 to collect the debt.

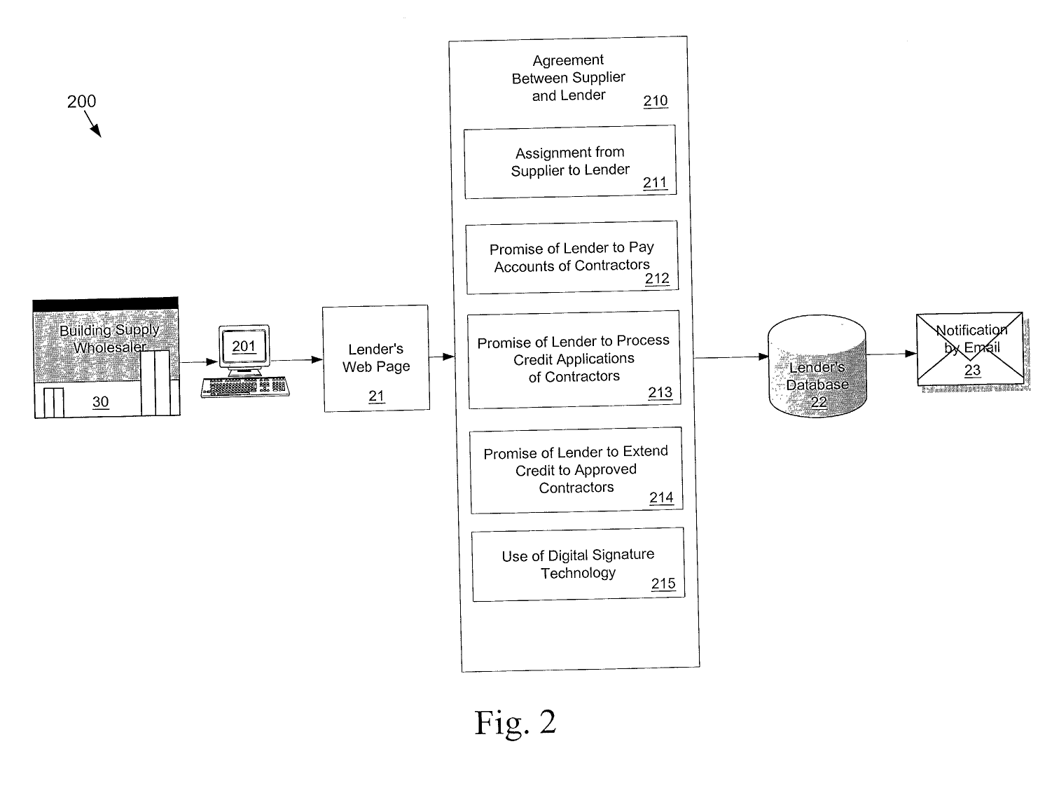

Referring to FIG. 2, a contractual agreement 200 is preferably entered into between a lender 20 and a building supply wholesaler 30 pursuant to which the lender 20 may agree to extend credit to a licensed building contractor 10 for the purpose of making a purchase of building materials 400 from the building supply wholesaler 30. In order to enter into such a contractual agreement 200, a building supply wholesaler 30 may use a computer terminal 201 connected to the Internet to download a lender's web page 21, which may set forth the terms and conditions of the contractual agreement 200 and may contain an agreement between the supplier and the lender 210. An agreement between the supplier and the lender 210 may include an assignment from the supplier to the lender 211 of the right to claim and record a mechanic's lien for building supplies obtained through a purchase of building materials 400, a promise of the lender to pay accounts of the contractors 212, a promise of the lender to process credit applications of the contractors 213, a promise of the lender to extend credit to approved contractors, and/or the use of digital signature technology 215 to execute the agreement between the supplier and the lender 210. After execution of an agreement between the supplier and the lender 210 by a lender 20 and a building supply wholesaler 30, a lender 20 may compile pertinent information regarding the building supply wholesaler 30 into a lender's database 22. Notification by email 23 may be employed to provide notice regarding an acceptance or rejection of an agreement between the supplier the and lender 210 by a lender 20.

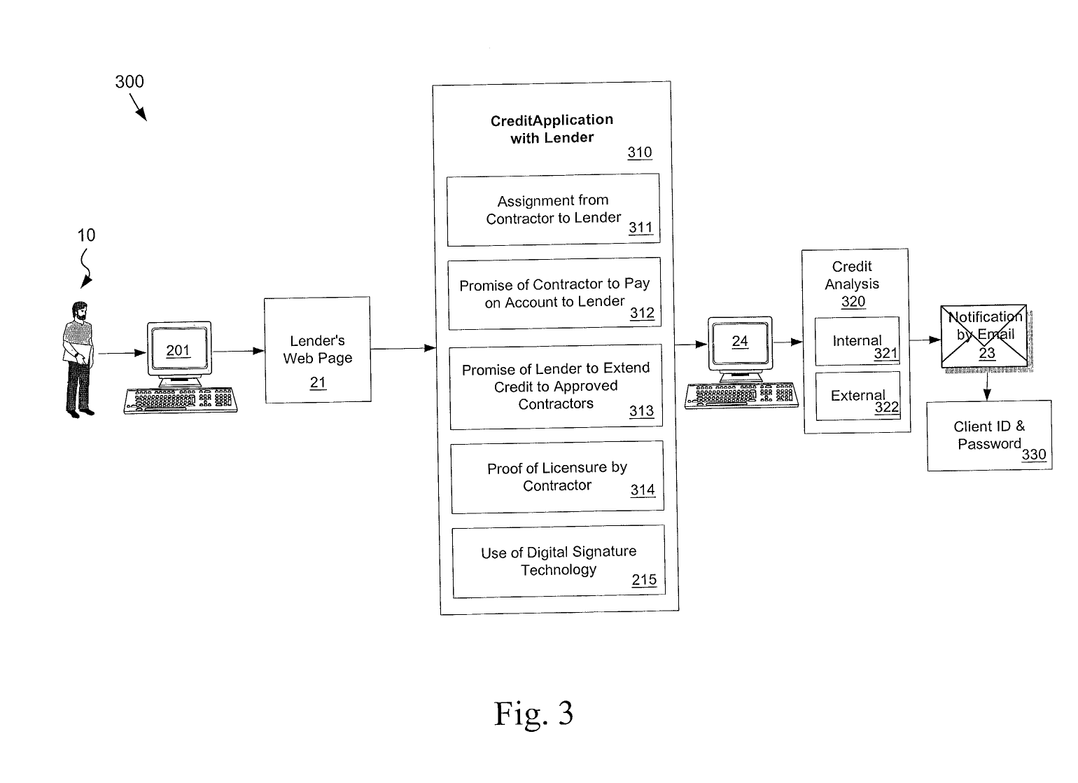

Referring to FIG. 3, a credit application and contractual agreement is preferably consummated between a contractor 10 and a lender 20, pursuant to which a lender 20 may agree to extend credit to a contractor 10 for the purpose of making a purchase of building supply materials 400 from a building supply wholesaler 30 with whom a lender 20 has already entered into a contractual agreement 200. In order to enter into such a credit application and contractual agreement 300, a contractor 10 may use a computer terminal 201 connected to the Internet to download a lender's web page 21, which may set forth the terms and conditions of a credit application and contractual agreement 300 and may contain a credit application with the lender 310. A credit application with lender 310 may include an assignment from the contractor to the lender 311 of the right to claim and record a mechanic's lien for building supplies obtained by the contractor 10 through a purchase of building materials 400, a promise of the contractor to pay on account to the lender 312, a promise of the lender to extend credit to approved contractors 313, proof of licensure by the contractor 314, and/or the use of digital signature technology 215 to execute the credit application with the lender 310.

After execution of a credit application with the lender 310 by a lender 20 and a contractor 10, a lender 20 may collect pertinent information regarding the contractor 10 and the credit application with the lender 310 into a lender's computer system 24. Upon compiling the information, a lender may conduct a credit analysis 320 regarding the creditworthiness of the contractor 10, which may include internal analysis 321, using a lender's own criteria, and/or an external analysis 322, using data purchased from a third-party credit reporter. Notification by E-mail 23 may be employed to provide notice regarding an acceptance or rejection of a credit application by the lender 20. In the event a credit application with the lender 310 is approved, the lender may provide a contractor with a client ID & password 330 for use in making a purchase of building materials 400.

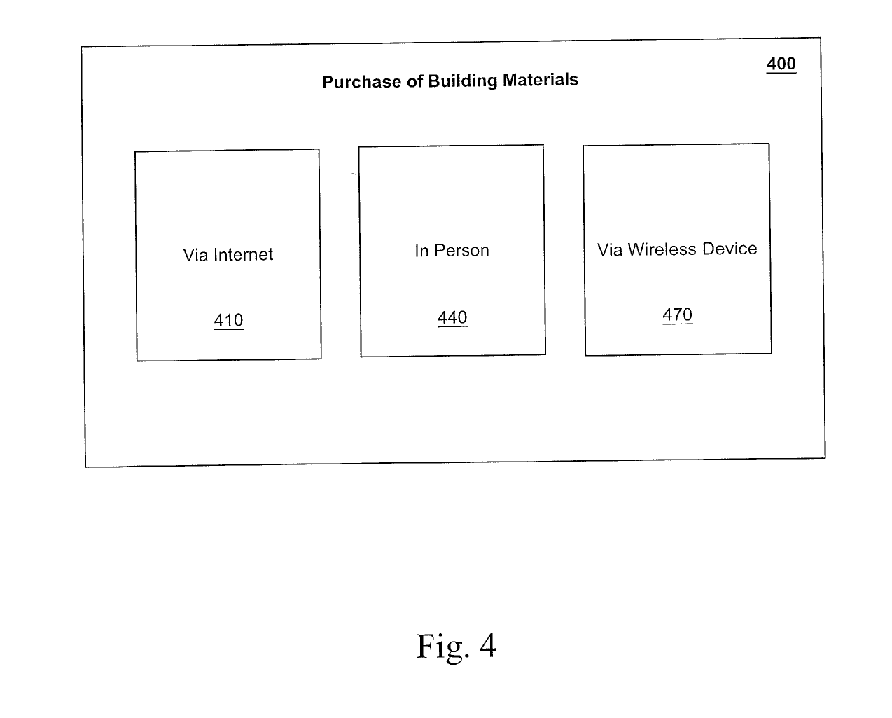

Referring to FIG. 4, a purchase of building materials 400 may be consummated via a plurality of methods, including via Internet 410, in person 440, and via a wireless device 470.

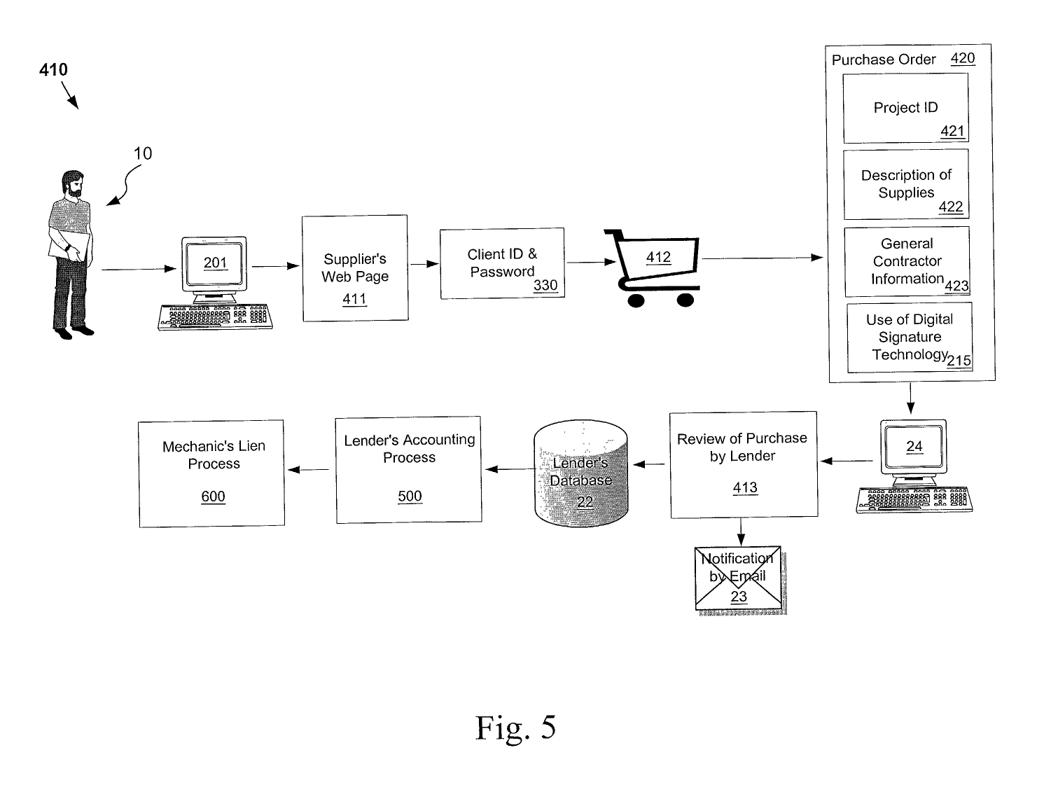

Referring to FIG. 5, in order to effect a purchase of building materials 400 via the Internet 410, a contractor 10 may use a computer terminal connected to the Internet 201 to access a supplier's web page 411. Upon accessing the supplier's web page 411, a contractor may input its client ID & password 330 and employ shopping cart software 412, made available through the supplier's web page 411, to select the desired building supplies and materials. While still on-line, a contractor 10 may then complete a purchase order 420 to complete the purchase of building materials 400. The purchase order 420 may include a project ID 421 sufficient to identify the building project for the purpose of recording a mechanic's lien, a description of supplies 422 purchased, general contractor information 423 detailing the identity of the general contractor with whom the contractor 10 has contracted to perform the work for which the supplies are being purchased, and/or the use of digital signature technology 215.

After completion of a purchase order 420, the information from the purchase order 420 may be electronically transferred into a lender's computer system 24. Upon compiling the information, a lender may conduct a review of purchase by lender 413 regarding the availability of credit to the contractor 10 for the contemplated and requested purchase of building materials 400. Notification by E-mail 23 may be employed to provide notice regarding an acceptance or rejection of a purchase order 420 by a lender 20. In the event a purchase order 420 is approved, data from the purchase order 420 and purchase of building materials 400 may be transferred to and stored in the lender's database 22. From the lender's database 22, the data may be transferred into a lender's accounting process 500 and ultimately, into a lender's mechanic's lien process 600 in the event of non-payment of the purchase price by the contractor 10.

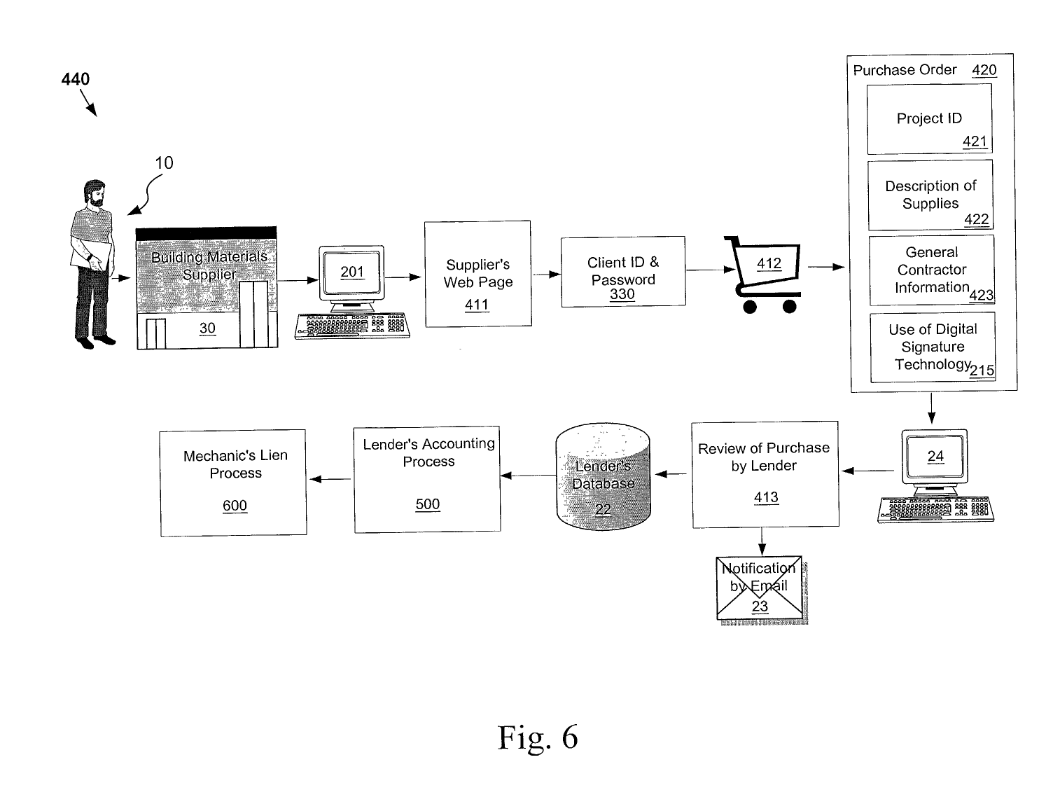

Referring to FIG. 6, in order to effect a purchase of building materials 400 in person 440, a contractor 10 may personally go to the premises of a building materials supplier 30 and may use a computer terminal connected to the Internet 201 to download a supplier's web page 411. The remainder of the purchase process in person 440 may be effected in the same manner as discussed previously for a purchase via the Internet 410.

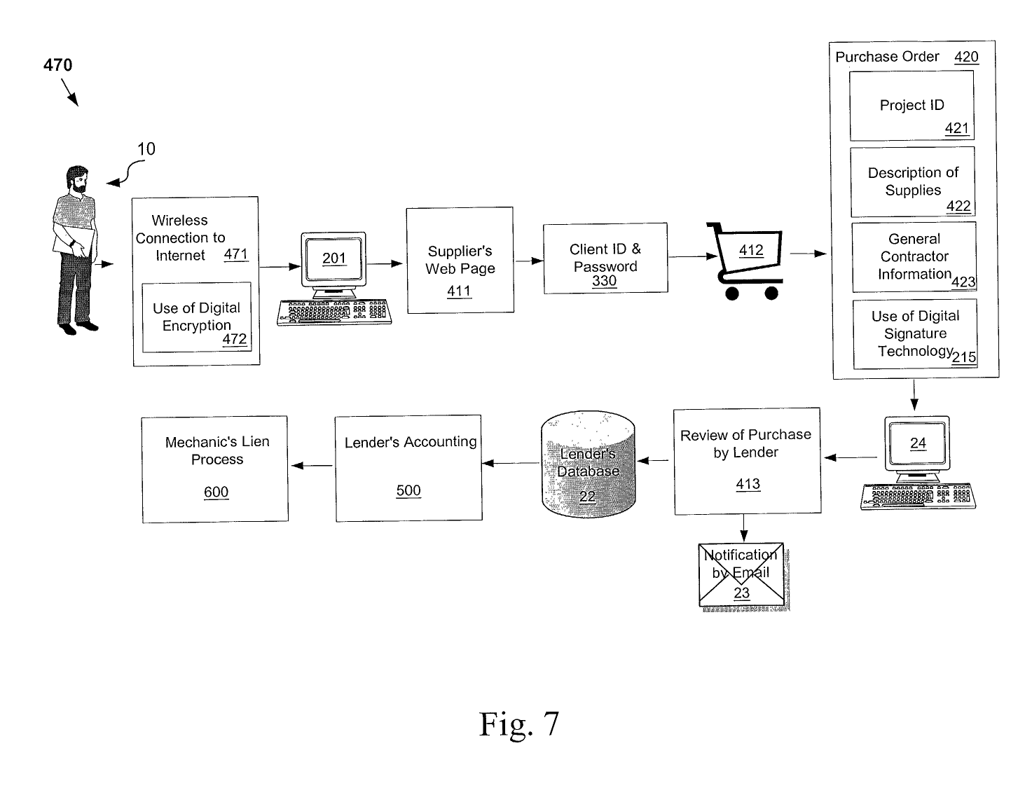

Referring to FIG. 7, in order to effect a purchase of building materials 400 via a wireless device 470, a contractor 10 may employ a wireless device, such as a cellular telephone, palmtop computer, pager, or other wireless device, to actuate a wireless connection to Internet 471 and thereby may use a computer terminal connected to the Internet 201 to download a supplier's web page 411. The wireless connection to the Internet 471 may employ a digital encryption 472 for security or other purpose. The remainder of the purchase process via the wireless device 470 may be effected in the same manner as discussed previously for a purchase via the Internet 410.

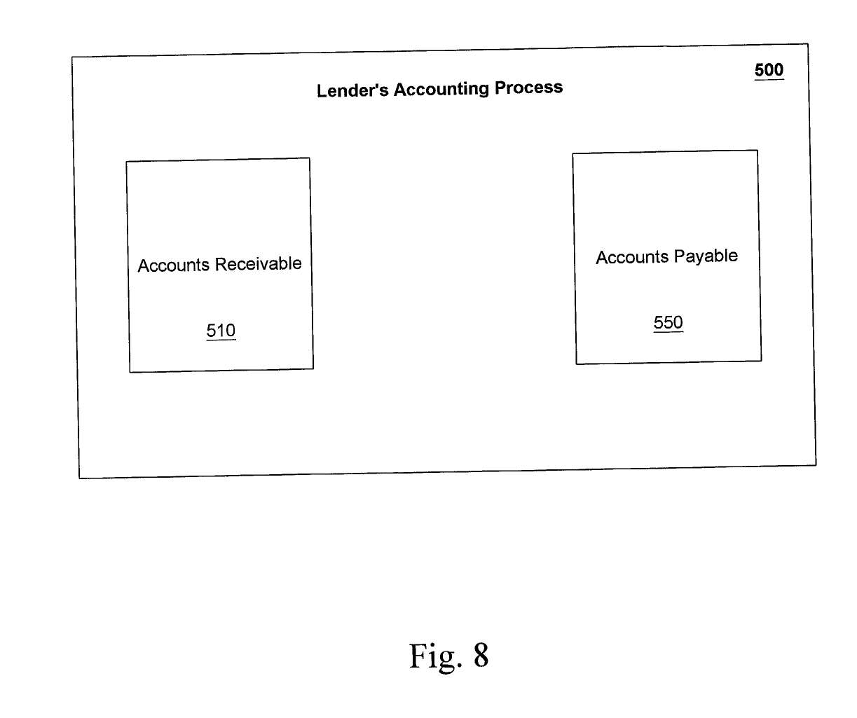

Referring to FIG. 8, a lender 20 may employ a lender's accounting process 500 to account for and track accounts receivable 510 and accounts payable 550.

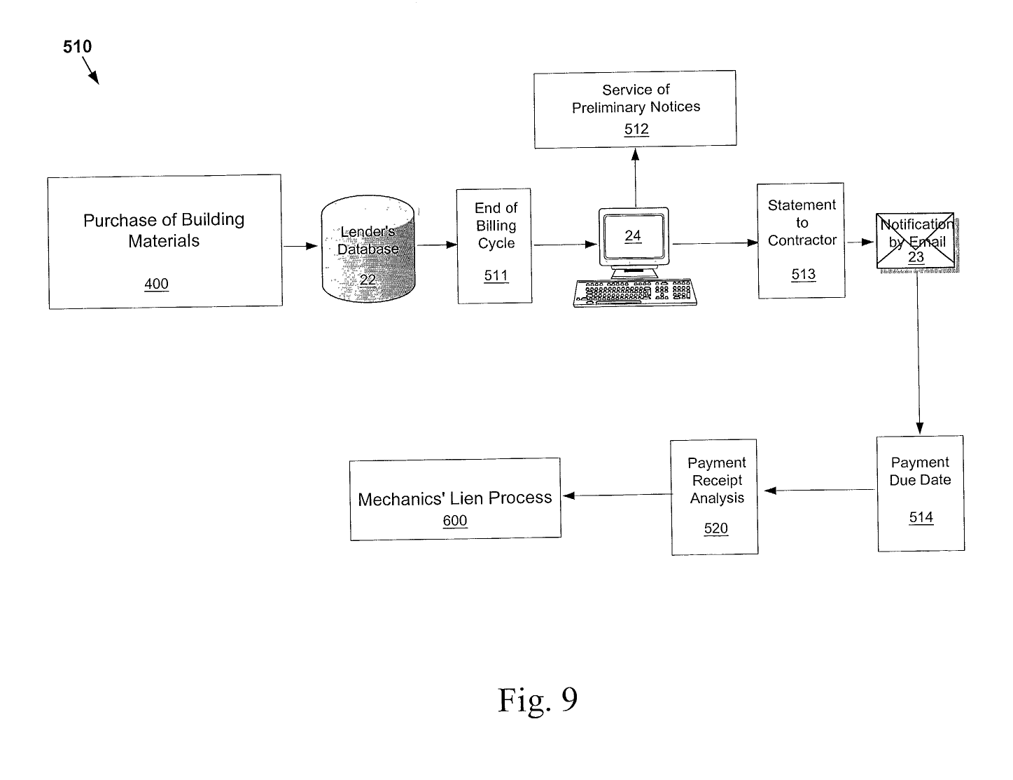

Referring to FIG. 9, in order to track its accounts receivable 510, a lender may implement the use of a lender's computer system 24 to track data compiled into a lender's 11 database 22 from a purchase of building materials 400. At the end of a billing cycle 511, typically the end of a calendar month, a lender 20 may employ a lender's computer system 24 to effect service of preliminary notices 512 if required by statute in the state where a lender 20 is extending credit to a contractor 10. A lender 20 may also employ a lender's computer system 24 to effect service of a monthly statement to a contractor 513. A statement to a contractor 513 may set forth all purchase of building materials 400 effected during the previous billing cycle. Notification by E-mail 23 may be employed to send a statement to a contractor 513. A statement to the contractor 513 may set forth a payment due date 514 which may be the 15^{th} of the month the statement to the contractor 513 is sent. On or about the payment due date 514, a lender may conduct a payment receipt analysis 520 for the purpose of evaluating implementation of a lender's mechanics' lien process 600.

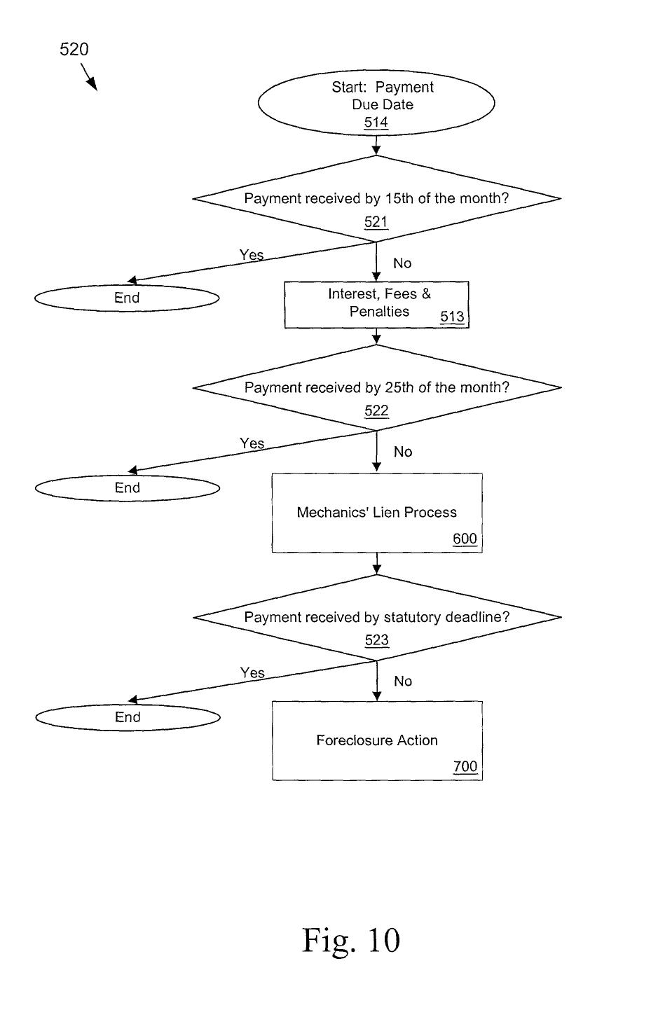

Referring next to FIG. 10, shown therein is one embodiment of a payment receipt analysis 520 that may be conducted by a lender 20. The starting point for the analysis may be the payment due date 514. In the event there has been payment received by the 15^{th} of the month 521, then the analysis terminates. In the event there has not been payment received by 15^{th} of the month 521, then interest, fees & penalties 513 accrue to the account of a contractor 10. In the event there has been payment received by the 25^{th} of the month 522, the analysis terminates. In the event there has not been payment received by the 25^{th} of the month 522, then the mechanics' lien process 600 is triggered. Finally, in the event there has been payment received by statutory deadline 523 pursuant to statute in the state in which the contractor 10 used the building materials, the analysis terminates. In the event there has not been payment received by statutory deadline 523 pursuant to statute in the state in which the contractor 10 used the building materials, then a foreclosure action 700 is triggered.

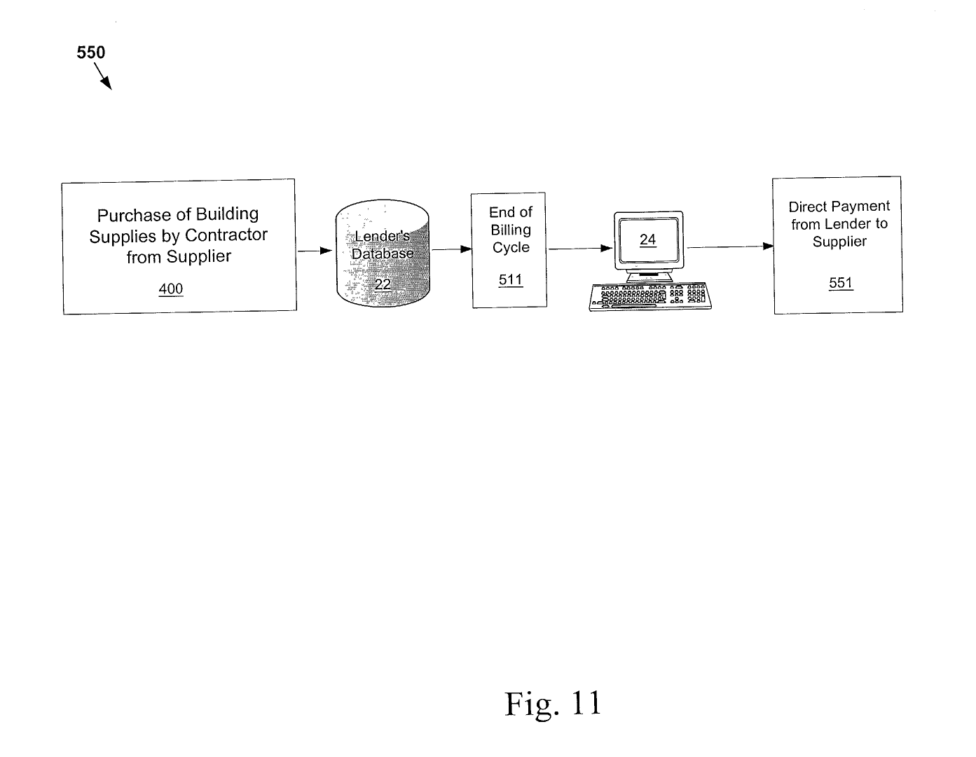

Referring to FIG. 11, in order to track its accounts payable 550, a lender may implement the use of a lender's computer system 24 to track data compiled into a lender's database 22 from a purchase of building materials 400. At the end of a billing cycle 511, typically the end of a calendar month, a lender 20 may employ a lender's computer system 24 to effect direct payment from the lender to a supplier 551, and may obviate the need for a building supply wholesaler 30 to engage in its own collection efforts for sales made on account.

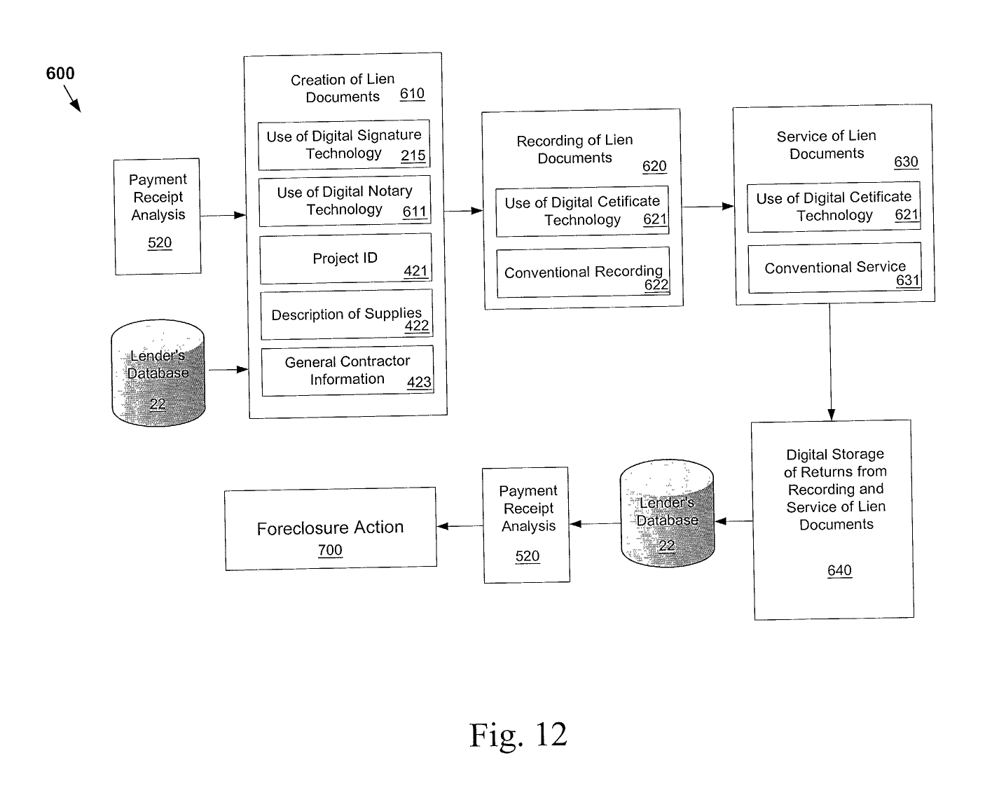

Referring to FIG. 12, a payment receipt analysis 520 may trigger a mechanics' lien process 600. The mechanics' lien process 600 may include the creation of lien documents 610, which, in turn, may include the use of digital signature technology 215, the use of digital notary technology 611, information regarding project ID 421, a description of supplies 422, and/or general contractor information 423, all of which may be assembled from a lender's database 22 wherein the data may have been previously stored. After effecting the creation of lien documents 610, a lender 20 may cause a recording of lien documents 620 to be accomplished, which may include the use of digital certificate technology 621 and/or the use of conventional recording 622. After recording of lien documents 620, a lender 20 may cause service of lien documents 630 to be effected, which may employ the use of digital certificate technology 621 and/or the use of conventional service 631.

After perfecting the service of lien documents, a lender 20 may employ the use of digital storage of returns from recording and service of lien documents 640, which may be effected by transfer into a lender's database 22. A lender 20 may then conduct further payment receipt analysis 520, which may include whether there has been payment received by statutory deadline 523. In the event there has not been payment received by statutory deadline 523 pursuant to statute in the state in which the contractor 10 used the building materials, then a foreclosure action 700 is triggered.

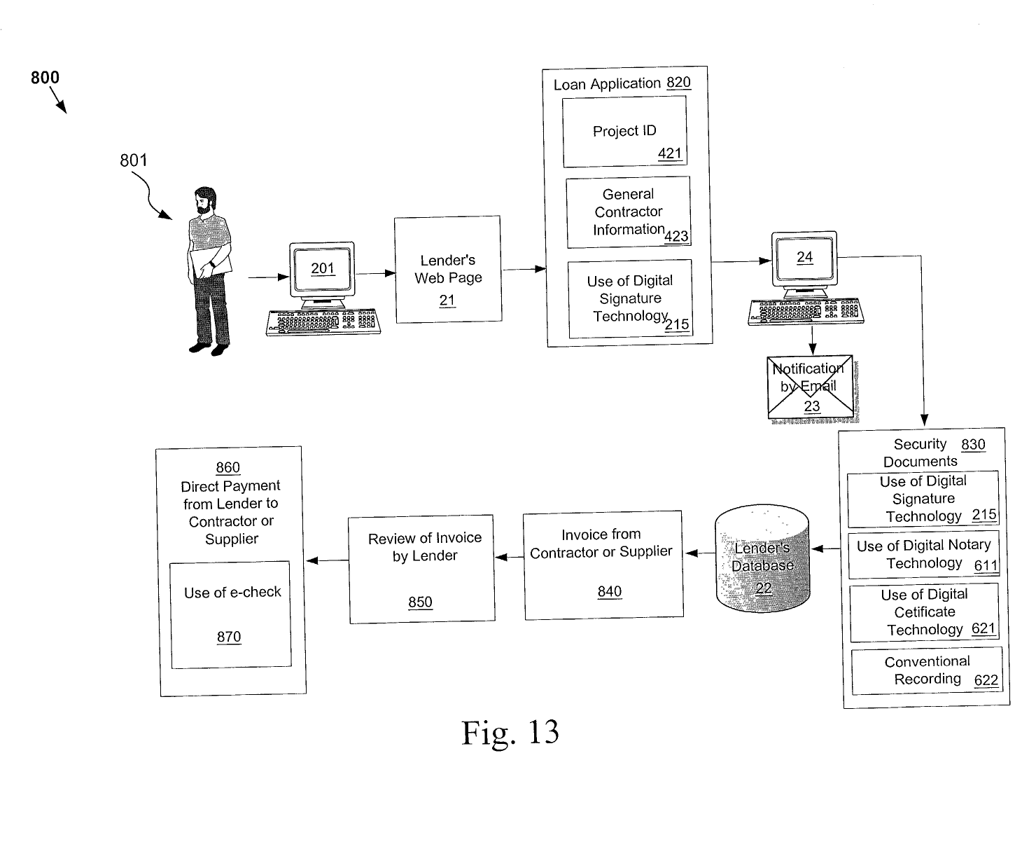

Referring finally to FIG. 13, another embodiment of the current invention is the extension of credit in the form of a construction loan 801. An owner 801 or contractor 10 may use a computer terminal connected to the Internet 201 to download a lender's web page 21, where the owner 801 or contractor 10 may complete a loan application 820, which may employ the use of a project ID 421, general contractor information 423 if any, and/or the use of digital signature technology 215. A lender may implement the use of a lender's computer system 24 to analyze the loan application 820 and may employ notification by E-mail 23 to provide a response to the owner 801 or contractor 10.

If a loan application 820 is approved by a lender 20, a lender 20 may implement the use of a lender's computer system 24 to generate and record loan security documents 830, which process may employ the use of digital signature technology 215, use of digital notary technology 611, use of digital certificate technology 621, and/or conventional recording 622. Data from the generation and recording of loan security documents 830 may then be transferred to a lender's database 22 for storage.

Upon receipt of an invoice from a contractor or a supplier 840, a lender 20 may conduct a review of invoice by lender 850, which may include a review of data stored on a lender's database 22. Upon approval of a disbursement, a lender may make direct payment from lender to the contractor or the supplier 860 and may employ the use of e-check 870 technology in making payment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. A method of extending automatically secured credit from a lender to a building contractor for purchasing building supplies from a building supply wholesaler, the method comprising:
entering into a contractual relationship between the lender and the building supply wholesaler; and
assigning to the lender the rights to record a lien against any building project for which the lender sells building supplies to the contractor on credit extended by the lender.

2. The method of claim 1, further comprising entering into a contractual relationship between the building contractor and the lender under which the contractor assigns to the lender its rights to record a lien against any building project for which the contractor purchases building supplies from a building supply wholesaler on credit extended by the lender.

3. The method of claim 1, wherein entering into the contractual relationship between the lender and the building supply wholesaler comprises electronically entering into the contractual relationship between the lender and the building supply wholesaler.

4. The method of claim 1, further comprising applying a digital signature to the contractual relationship between the lender and the building supply wholesaler.

5. The method of claim 1, further comprising electronically purchasing building materials from the building supply wholesaler on credit extended by the lender.

6. The method of claim 1, further comprising electronically obtaining the information for each building project for which credit is extended by lender sufficient to record a lien against the building project for the purpose of securing the credit extended by lender.

7. The method of claim 1, further comprising assigning and using unique identification numbers for each building project for which credit is extended to the building contractor to purchase building supplies from the wholesaler.

8. The method of claim 1, further comprising using digital signatures and digital notary public acknowledgments in the process of serving preliminary and recording notices regarding liens to appropriate state and municipal agencies.

9. The method of claim 1, further comprising using digital signatures and digital notary public acknowledgments in the process of recording liens at appropriate state and municipal agencies.

10. The method of claim 1, further comprising using electronic means to receive notification from state and municipal agencies regarding official certification of lien recording and receipt of preliminary lien notices.

11. The method of claim 1, further comprising using electronic means to track and store transmitted preliminary lien notices and liens, as well as official certification of lien recording and receipt of preliminary lien notices.

12. The method of claim 1, further comprising using computer software for the purpose of automatically sending preliminary lien notices to contractors and appropriate state and municipal agencies, recording liens, checking for certification of lien recording and receipt of preliminary lien notices, and sending lien recording notices to contractors and building project property owners.

13. The method of claim 1, further comprising developing a network of contractors and building supply wholesalers which use lender's credit supplying services.

14. The method of claim 1, further comprising providing information regarding members of the network of contractors and building supply wholesalers which use lender's credit supplying services to other members of the network.

15. A method for using a computer to facilitate a transaction between a lender and a building contractor for extending automatically secured credit used in purchasing building supplies from a building supply wholesaler, the method comprising:
inputting into the computer an offer to enter into a contractual relationship between the lender and the building supply wholesaler including assigning to the lender the rights to record a lien against any building project for which the lender sells building supplies to the contractor on credit extended by the lender;
outputting to the lender the offer from the building supply wholesaler to enter into the contractual relationship;
inputting into the computer an acceptance to the building supply wholesaler from the lender;
inputting into the computer an offer to enter into a contractual relationship between a building contractor and the lender under which the contractor assigns to the lender its rights to record a lien against any building project for which the contractor purchases building supplies from a building supply wholesaler on credit extended by the lender;
outputting to the lender the offer from the contractor to enter into the contractual relationship;
inputting into the computer an acceptance to the contractor from the lender;
applying a digital signature to the contractual relationship between the lender and the building supply wholesaler; and
applying a digital signature to the contractual relationship between the lender and the contractor.

16. A method of extending credit in the form of a construction loan from a lender to a building project owner, the method comprising:
electronically completing a construction loan application; and
electronically completing security documents for the loan.

17. The method of claim 16, further comprising applying digital signatures and digital notary public acknowledgments to the execution of the loan and security documents and recording said documents with the appropriate state and municipal agencies.

18. The method of claim 16, further comprising using electronic means to receive notification from state and municipal agencies regarding official certification of loan security document recording.

19. The method of claim 16, further comprising making payments directly to suppliers of building materials and labor for the construction project for which the construction loan was issued, including building supply wholesalers and building contractors who are part of the lender's automatically secured credit extension network.

20. The method of claim 16, further comprising making payments directly to building supply wholesalers and building contractors who are part of the lender's automatically secured credit extension network from proceeds of the construction loan issued to the building project owner.

21. The method of claim 16, further comprising using a computer to ensure that credit is not extended beyond the approved amount for any construction loan.
